(19) United States
(12) Patent Application Publication
(10) Pub. No.: US 2007/0031555 A1
(43) Pub. Date: Feb. 8, 2007

(54) Direct starch molding

(76) Inventors: Glen S. Axelrod, Colts Neck, NJ (US); Ajay Gajria, Monmouth Junction, NJ (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/198,881

(22) Filed: Aug. 5, 2005

(51) Int. Cl. A23L 1/00

(52) U.S. Cl. 426/516; 426/661

(57) ABSTRACT

The present invention relates to an animal chew including an edible starch. The invention relates to a method of molding the animal chew in which starch and other additives may be introduced directly into an injection molding machine and molded to a desired shape. The starch may include fermented soy product, enzymes and/or coenzymes.

### FIELD OF INVENTION

The present invention relates to the direct injection molding of an edible starch based animal chew corn positions. The processing conditions, including barrel temperatures may also be adjusted along with additive amount and water levels to provided molded starch products. The starch may include fermented soy product, enzymes and/or coenzymes.

### BACKGROUND

Numerous disclosures exist pertaining to the development of edible dog chews that are digestible and/or nutritious along with a texture that can be individually adjusted to suit a wide variety of a dog's preferences or needs. Attention is therefore directed to the following exemplary disclosures: U.S. Pat. No. 6,180,161 “Heat Modifiable Edible Dog Chew”; U.S. Pat. No. 6,159,516 “Method of Molding Edible Starch”; U.S. Pat. No. 6,126,978 “Edible Dog Chew”; U.S. Pat. No. 6,110,521 “Wheat and Casein Dog Chew with Modifiable Texture”; U.S. Pat. No. 6,093,441 “Heat Modifiable Peanut Dog Chew”; U.S. Pat. No. 6,093,427 “Vegetable Based Dog Chew”; U.S. Pat. No. 6,086,940 “High Starch Content Dog Chew”; U.S. Pat. No. 6,067,941 “Animal Chew”; U.S. Pat. No. 6,056,991 “Turkey and Rice Dog Chew With Modifiable Texture”; U.S. Pat. No. 5,941,197 “Carrot Based Dog Chew”; U.S. Pat. No. 5,827,565 “Process for Making an Edible Dog Chew”; U.S. Pat. No. 5,339,771 “Animal Chew Toy Containing Animal Meal”; U.S. Pat. No. 5,240,720 “Dog Chew with Modifiable Texture”; U.S. Pat. No. 5,200,212 “Dog Chew with Modifiable Texture.” Attention is also directed to U.S. Pat. No. 6,165,474 entitled “Application for Patent for Nutriceutical Toy” and U.S. Pat. No. 5,419,283 entitled “Animal Chew Toy of Starch Material and Degradable Ethylene Copolymer”. These disclosures provide non-limiting examples of starch based molding compositions and molding methods.

### SUMMARY

In an exemplary embodiment, the present invention relates to a method for direct injection molding raw starch in an injection molding machine to produce an animal chew. The injection molding machine may include a screw, a barrel and a mold. Raw starch, water and optionally plasticizer may be introduced directly into the barrel of the injection molding machine. The starch, plasticizer and water may be mixed in the barrel to form a starch composition. The starch composition may then be formed. The starch may contain fermented soy product, enzymes and/or coenzymes.

### BRIEF DESCRIPTION OF DRAWINGS

Features and advantages of the present invention are set forth herein by description of embodiments consistent with the present invention, which description should be considered in conjunction with the accompanying drawings, wherein:

FIG. 1 is an exemplary embodiment of an injection molding machine.

### DETAILED DESCRIPTION

The present invention relates to the direct injection molding of starch based edible animal chew compositions. The additives of the starch based composition may be added directly into an injection molding machine to provide a molded starch based animal chew in a single step.

The starch composition may include any carbohydrate of natural or vegetable origin. The starch may include amylose and/or amylopectin and may be extracted from plants, including but not limited to potatoes, rice, tapioca, corn and cereals such as rye, wheat, and oats. The starch may also be extracted from fruits, nuts and rhizomes, or arrowroot, guar gum, locust bean, arracacha, buckwheat, banana, barley, cassava, konjac, kudzu, oca, sago, sorghum, sweet potato, taro, yams, fava beans, lentils and peas. The starch may be present between about 30-99% including all increments and values therebetween such as levels above about 50%, 85%, etc.

The starch employed herein may be raw starch, which may be understood as starch that has not seen a prior thermal molding history, such as extrusion or other type of melt processing step. The raw starch itself may also be native, which may be understood as unmodified starch recovered in the original form by extraction and not physically or chemically modified. The raw starch may also be in powder form of varying particle size, which may be understood as milled and/or pre-sifted. It should be understood that the raw starch may also have varying degrees moisture present. Accordingly, it should be appreciated that the term “direct” as used herein with respect to injection molding refers to the molding of starch without exposing the starch to prior thermal molding histories before injection molding. However, the starch herein may, e.g., be heated for drying purposes, which would not amount to a prior thermal molding history.

The starch composition may include cellulose. The cellulose may be, for example, a long-chain polymer of polysaccharide carbohydrate. The cellulose may also be derived or extracted from plants. The cellulose may be incorporated into the starch composition between about 1-15% by weight of the starch composition and any increment or value therebetween including 4%, 10%, 11%, etc.

Emulsifiers or surfactants may also be incorporated into the starch composition. The emulsifier may be present between about 1-10% by weight of the starch composition and all increments or values therebetween including 3%, 4%, etc. The emulsifier may include, for example, lecithin, which may be extracted or derived from, for example, egg yolk or soy beans.

The starch composition may also include a plasticizer. The plasticizer may include for example, glycerin. The plasticizer may be incorporated between about 15-30%, including all increments and values therebetween such as levels greater than 15%, 21%, 27% etc.

A humectant may also be incorporated into the starch composition. The humectant may include, for example, oat fiber. The humectant may be incorporated between about 0.1-5% by weight of the starch composition including all intervals and values therebetween, including 1%, 25%, etc. A humectant may be understood to be any additive that may absorb water in the material.

The starch composition may also include water. The water may be introduced into the composition between about 1-40% by weight of the starch composition and any increment or value therebetween, including 4%, 20-40%, 10-20%, etc. After the product has been formed, the water may be present between 1-20% by weight of the starch composition including all increments or values therebetween, such as, below 20%, 4%, 5-10%, etc.

The starch composition may include a nutraceutical. The nutraceutical may be fermented soya. Fermented soya nutraceuticals are available from Bio Food, Ltd., Pine Brook, N.J. and sold under the general trademark Soynatto®. The fermented soya is present between about 1-40% by weight of the starch composition, including all increments and values therbetween, including 10%, 20%, etc. The Soynatto® product is more specifically described to contain the following as compared to other available compositions:

| Made With | | | | | | Constituants* | | |
|---|---|---|---|---|---|---|---|---|
| | Units per | Foods* | | | | Soy protein | Soy milk | Tofu, |
| Nutrient | 100 g | IEFS | Soynatto ® | Tempeh | Miso Paste | isolate | as fluid | regular |
| Proximates | | | | | | | | |
| Protein | g | 37.00 | 37.00 | 18.54 | 11.81 | 80.69 | 2.75 | 8.08 |
| Total lipid | g | 7.50 | 7.50 | 10.80 | 6.07 | 3.39 | 1.91 | 4.78 |
| Carbohydrate | g | 40.00 | 40.00 | 9.39 | 27.96 | 7.36 | 1.81 | 1.88 |
| Fiber, total dietary | g | 12.02 | 12.02 | | 5.40 | 5.60 | 1.30 | 0.30 |
| Minerals | | | | | | | | |
| Calcium | mg | 151.50 | 151.50 | 111.00 | 66.00 | 178.00 | 4.00 | 350.00 |
| Iron | mg | 5.21 | 5.21 | 2.70 | 2.74 | 14.50 | 0.58 | 5.36 |
| Magnesium | mg | 191.25 | 191.25 | 81.00 | 42.00 | 39.00 | 19.00 | 30.00 |
| Phosphorus | mg | 608.25 | 608.25 | 266.00 | 153.00 | 776.00 | 49.00 | 97.00 |
| Potassium | mg | 1957.50 | 1957.50 | 412.00 | 164.00 | 81.00 | 141.00 | 121.00 |
| Sodium | mg | 18.30 | 18.30 | 9.00 | 3647.00 | 1005.00 | 12.00 | 7.00 |
| Zinc | mg | 3.84 | 3.84 | 1.14 | 3.32 | 4.03 | 0.23 | 0.80 |
| Copper | mg | 3.93 | 3.93 | 0.56 | 0.44 | 1.60 | 0.12 | 0.19 |
| Manganese | mg | 2.40 | 2.40 | 1.30 | 0.86 | 1.49 | 0.17 | 0.61 |
| Selenium | mcg | 27.98 | 27.98 | 0.02 | 1.60 | 0.80 | 1.30 | 8.90 |
| Lithium | mcg | 60.00 | 60.00 | tr | tr | tr | tr | tr |
| Molybdenum | mcg | 6.00 | 6.00 | tr | tr | tr | tr | tr |
| Nickel | mcg | 30.00 | 30.00 | tr | tr | tr | tr | tr |
| Tin | mcg | 12.00 | 12.00 | tr | tr | tr | tr | tr |
| Lipids | | | | | | | | |
| Fatty acids, saturated | g | 1.22 | 1.22 | 2.22 | 0.88 | 0.42 | 0.21 | 0.69 |
| Fatty acids, | g | 1.70 | 1.70 | 3.00 | 1.34 | 0.65 | 0.33 | 1.06 |
| monounsaturated | | | | | | | | |
| Fatty acids, | g | 4.14 | 4.14 | 3.83 | 3.43 | 1.65 | 0.83 | 2.70 |
| polyunsaturated | | | | | | | | |
| Omega-6 Fatty Acid | g | 3.57 | 3.57 | 3.59 | 3.02 | 1.45 | 0.74 | 2.38 |
| Omega-3 Fatty Acid | g | 0.55 | 0.55 | 0.22 | 0.41 | 0.20 | 0.10 | 0.32 |
| Vitamins | | | | | | | | |
| Thiamin | mg | 1.79 | 1.79 | 0.08 | 0.10 | 0.18 | 0.16 | 0.08 |
| Riboflavin | mg | 1.04 | 1.04 | 0.36 | 0.25 | 0.10 | 0.07 | 0.05 |
| Niacin | mg | 7.62 | 7.62 | 2.64 | 0.86 | 1.44 | 0.15 | 0.20 |
| Pantothenic acid | mg | 2.34 | 2.34 | 0.28 | 0.26 | 0.06 | 0.05 | 0.07 |
| Vitamin B-6 | mg | 0.99 | 0.99 | 0.22 | 0.22 | 0.10 | 0.04 | 0.05 |
| Folic | mcg | 532.50 | 532.50 | 23.90 | 33.00 | 176.10 | 1.50 | 15.00 |
| Vitamin A | IU | 30.00 | 30.00 | 0.00 | 87.00 | 0.00 | 32.00 | 85.00 |
| Vitamin E | mg_ATE | 0.15 | 0.15 | tr | 0.01 | 0.00 | 0.01 | tr |
| Biotin | mg | 0.02 | 0.02 | tr | tr | tr | tr | tr |
| Choline | mg | 60.00 | 60.00 | tr | tr | tr | tr | tr |
| Inositol | mg | 72.00 | 72.00 | tr | tr | tr | tr | tr |
| PABA | mg | 6.00 | 6.00 | tr | tr | tr | tr | tr |
| Special Nutrients | | | | | | | | |
| Isoflavones | mg | 4000.00 | 200.00 | 43.52 | 42.55 | 97.43 | 9.65 | 23.61 |
| Glycogen | g | 1.10 | 1.10 | tr | tr | tr | tr | tr |
| Beta Glucans | g | 0.50 | 0.50 | tr | tr | tr | tr | tr |
| Glutathione | mg | 60.00 | 60.00 | tr | tr | tr | tr | tr |
| SOD | unit | 1650.00 | 1650.00 | tr | tr | tr | tr | tr |
| RNA/DNA | g | 1.05 | 1.05 | | | | | |

An Empty Cell indicates a value is un-known;
“tr” indicates a value is probably a trace or none.

As can be seen from the above, the Soynatto® product may provide proteins, minerals, and vitamins, in a fermented soy form. The fermentation process may infuse the product with saccharomyces cerevisiae, commonly known as “bakers yeast” or “brewers yeast.” Saccharomyces cerevisiae is more traditionally known to ferment sugars present in flour or dough, yielding carbon dioxide and alcohol. Accordingly, it should be appreciated that a protein, one or more of a mineral, and one or more of a vitamin, along with saccharomyces cerevisiae may be present in the starch composition.

The fermented soy product herein may include increased concentrations of glycitein, daidzein and genistein, reportedly present at several hundred percent more than other more common soyfood sources. Glycitein, daidzein and genistein belong to the isoflavone class of flavanoids and may be classified as phytoestrogen, since they are plant derived nonsteriodal compounds that contain estrogen-like biological activity.

In the context of the present invention, the direct injection molding of the fermented soy product may offer advantages with respect to the activity of the soy product in a final molded shape. Specifically, the direct injection molding provides that the fermented soy product is not substantially degraded and the nutritional value of the fermented soy product remains substantially unchanged.

The starch composition may also include enzymes and/or co-enzymes which are similarly available through Bio Foods, Ltd., Pine Brook, N.J. and sold under the trademark of BT-CoQ10®. This reportedly is a biologically transformed (fermented) cell mitochondrial coenzyme and contains Coenzyme Q10, antioxidants, phytonetrients and cofactor mineral nutrients and other cell constituents. The enzymes and/or co-enzymes may be present between 0.1-10% by weight of the starch composition, including all increments and values therebetween such as 1%, 5%, etc.

Reportedly, the coenzyme Q10 is a fat-soluble compound primarily synthesized by the body and also consumed in the diet and is required for mitochondrial ATP synthesis. The fermented coenzyme also reportedly belongs to the family of compounds known as ubiquinones, which are either of two isomeric cyclic crystalline compounds C₆H₄O₂ that are di-keto derivatives of dihydro-benzene. It may also function as an antioxidant in cell membranes and lipoproteins.

Other additives may be introduced into the composition as well. These additives may include vegetable matter, fruit matter, rawhide, nuts, nut bits or nut flour such as peanut flour, and animal or fish products, by-products, meal or digests, etc. Glutens may also be incorporated into the starch composition. Gluten may be understood as water-insoluble protein complex extracted from cereal grains such as maize or corn and wheat. These additives may be present individually or cumulatively between about 0.1-50% by weight of the starch composition and all increments and values therebetween including 0.1-5.0%, 15%, 25%, etc.

Additionally, flavorants, herbs, herbal extracts, vitamins, minerals, colorants, yeast products, soy products, attractants, etc, may be incorporated into the starch composition. Yeast products may include nutritional yeast or brewers yeast such as saccharomyces cerevisiae, dairy yeast such as kluyveromyce marxianus or wine yeast such as saccharomyces fermentati. The soy products may include fermented soy or other soy products, as listed in the table above. Attractants may include compounds listed herein, such as the animal or fish digests, or other compounds that may increase an animal's interest in the starch composition. These additives may be present individually or cumulatively between about 0.01-25% by weight of the starch composition and any increment or value therebetween including 0.01-0.5%, 10%, 20%, etc. The composition may also include calcium carbonate. The calcium carbonate may be present between about 5-10%.

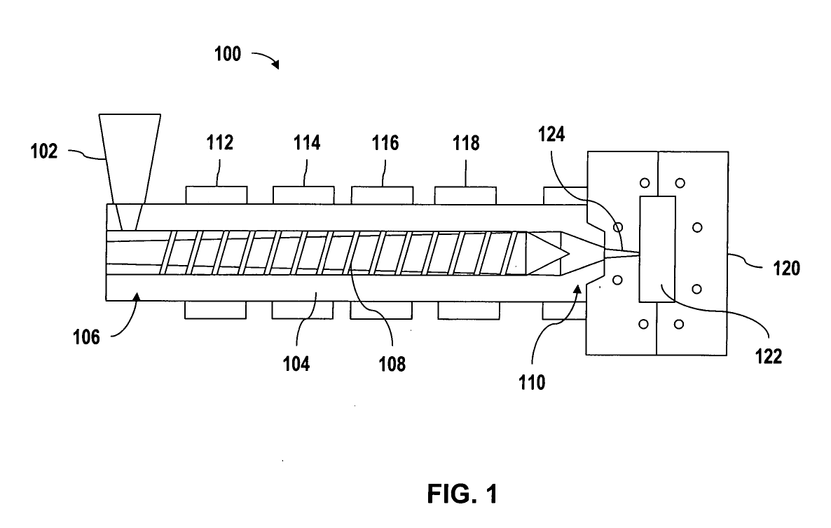

The additives of the starch composition may be introduced directly into the barrel of an injection molding machine 100, illustrated in FIG. 1, through a hopper or other feeding device 102. Various feeding devices for introducing the additives into the injection molding barrel may be contemplated including loss-in weight gravimetric blenders/feeders, auger feeders, venturi loaders, etc. Those skilled in the art will appreciate that an injection molding machine 100 typically contains a barrel 104 including a feed section 106, a screw 108 and an output nozzle 110. The barrel 104 may include a plurality of temperature control zones 112, 114, 116, 118 in the barrel extending from the feed sction 106 section to the nozzle 110. The injection molding machine may include a mold 120 having one or more cavities 122. The molding machine may also be vented, including a vented barrel and/or a vented mold.

The temperature adjustment may vary for each zone. For example, in one exemplary embodiment, the molding machine barrel may include 4 zones, zone 1 112 being the closest to the feed section 106 and zone 4 118 being the closest to the nozzle 110. Zone 1 112 may be set to less than about 150 degrees F., including any increment or value between about 35 to 150 degrees F. including between about 46 to 150 degrees F., 46 to 70 degrees F., etc. Similarly zone 2 114 may be set between about 70 to 150 degrees F. including any increment or value therebetween, zone 3 116 between about 50 to 300 degrees F. including any increment or value therebetween, and zone 4 118 between about 200 to 375 degrees F. including any increment or value therebetween. The nozzle 110 may be set between about 250 to 390 degrees F. including any increment or value therebetween. The bushing 124 inside of the mold 120 may be set between about 250 to 425 degrees F. including any increment or value therebetween and the mold 120 may also be set between about 35 to 65 degrees F. including any increment or value therebetween.

Once introduced into the barrel 104 of the molding machine 100 the additives may be blended as the screw 108 conveys the material towards the mold 120 where the starch composition may be formed. The mold 120 may cool the starch composition. Once molded, and venting takes place, the starch composition may include water between about 1-20% by weight of the starch composition, including all increments and values therebetween such as 10%, 15%, etc. The starch composition may be molded into any form capable of being produced in an injection molding cavity.

The foregoing description is provided to illustrate and explain the present invention. However, the description hereinabove should not be considered to limit the scope of the invention set forth in the claims appended here to.

What is claimed is:

1. A method for direct injection molding raw starch in an injection molding machine including a screw, a barrel and a mold to produce an animal chew, comprising:
introducing raw starch, plasticizer, and water directly into the barrel of the injection molding machine, wherein said starch is present at levels greater than about 50% by weight, and said plasticizer is present at levels greater than about 15% by weight;
mixing said starch, said plasticizer and said water in said barrel to form a starch composition;
forming said starch composition into a molded shape.

2. The method of claim 1 wherein said step of introducing said starch, said plasticizer and said water directly into the barrel of the injection molding machine further comprises including an additive.

3. The method of claim 1 wherein said plasticizer comprises glycerin.

4. The method of claim 2 wherein said additive is selected from the group consisting of emulsifiers, cellulose and combinations thereof.

5. The method of claim 4 wherein said emulsifier comprises lecithin.

6. The method of claim 4 wherein in said starch composition said starch is present between about 50-99% by weight of the starch composition, said water is present between about 1-10% by weight of the starch composition, said cellulose is present between about 1-15% by weight of the starch composition, said emulsifiers are present between about 1-10% by weight of the starch composition and said plasticizer is present above about 15% by weight of the starch composition.

7. The method of claim 2 wherein said additive is selected form the group consisting of humectants, vegetable matter, fruit matter, animal products, animal by-products, animal digests, animal meal, fish products, fish by-products, fish digests, fish meal, rawhide, nuts, nut bits, nut flour, flavorants, attractants, herbs, herbal extracts, vitamins, minerals colorants, yeast products, soy products, calcium carbonate and combinations thereof.

8. The method of claim 7 wherein said additive is present between about 0.1 to 25% by weight of said starch composition.

9. The method of claim 2 wherein said additive is selected from the group consisting of gluten, fermented soy products and combinations thereof.

10. The method of claim 9 wherein said additive is present between about 0.1 to 40% by weight of said starch composition.

11. The method of claim 2 wherein said additive comprises enzymes/coenzymes.

12. The method of claim 11 wherein said additive is present between about 0.1-10% by weight of said starch composition.

13. The method of claim 1 wherein said barrel further includes a feed section and a nozzle including a plurality of temperature control zones in said barrel extending from said feed section to said nozzle.

14. The method of claim 13 wherein said barrel adjacent to said feed section is maintained at a temperature less than about 150 degrees F.

15. The method of claim 13 wherein said plurality of temperature control zones in said barrel are set within the following temperature ranges:
zone 1 is set between about 35 to 150 degrees F.;
zone 2 is set between about 70 to 150 degrees F.;
zone 3 is set between about 50-300 degrees F.; and
zone 4 is set between about 200-375 degrees F.

16. The method of claim 1 wherein said mold is set at a temperature between about 35 to 65 degrees F.

17. The method of claim 1 wherein said mold includes a bushing and said bushing temperature is set between about 250 to 425 degrees F.

18. The method of claim 13 wherein said nozzle is set at a temperature between about 250 to 390 degrees F.

19. The method of claim 1 wherein said barrel is vented.

20. The method of claim 1 wherein said mold is vented.

21. A method for direct injection molding raw starch in an injection molding machine including a screw, a barrel and a mold to produce an animal chew, comprising:
introducing raw starch and water directly into the barrel of the injection molding machine, wherein said starch is present at levels greater than about 50% by weight, wherein said starch includes fermented soy product;
mixing said starch, water and fermented soy product in said barrel to form a starch composition; and
forming said starch composition into a molded shape.

22. The method of claim 21 wherein said raw starch further includes gluten.

23. The method of claim 21 wherein said raw starch further includes a plasticizer.

24. The method of claim 23 wherein said plasticizer comprises glycerin.

25. The method of claim 21 wherein said barrel further includes a feed section and a nozzle including a plurality of temperature control zones in said barrel extending from said feed section to said nozzle.

26. The method of claim 25 wherein said barrel adjacent to said feed section is maintained at a temperature less than about 150 degrees F.

27. The method of claim 25 wherein said plurality of temperature control zones in said barrel are set within the following temperature ranges:
zone 1 is set between about 35 to 150 degrees F.;
zone 2 is set between about 70 to 150 degrees F.;
zone 3 is set between about 50-300 degrees F.; and
zone 4 is set between about 200-375 degrees F.

28. The method of claim 21 wherein said mold is set at a temperature between about 35 to 65 degrees F.

29. The method of claim 21 wherein said mold includes a bushing and said bushing temperature is set between about 250 to 425 degrees F.

30. A method for direct injection molding raw starch in an injection molding machine including a screw, a barrel and a mold to produce an animal chew, comprising:
introducing raw starch and water directly into the barrel of the injection molding machine, wherein said starch is present at levels greater than about 50% by weight,
mixing said starch and said water in said barrel to form a starch composition;
wherein said barrel further includes a feed section and a nozzle including a plurality of temperature control zones in said barrel extending from said hopper section to said nozzle, wherein said barrel adjacent to said feed section is maintained at a temperature less than about 150 degrees F. and wherein said plurality of temperature control zones in said barrel are set within the following temperature ranges:
zone 1 is set between about 35 to 150 degrees F.;
zone 2 is set between about 70 to 150 degrees F.;
zone 3 is set between about 50-300 degrees F.;
zone 4 is set between about 200-375 degrees F.; and
forming said starch composition into a molded shape.

31. A method for direct injection molding raw starch in an injection molding machine including a screw, a barrel and a mold to produce an animal chew, comprising:
introducing raw starch and water directly into the barrel of the injection molding machine, wherein said starch is present at levels greater than about 50% by weight, wherein said starch includes enzymes/coenzymes;
mixing said starch, water and enzymes/coenzymes in said barrel to form a starch composition; and
forming said starch composition into a molded shape.

32. The method of claim 31 wherein said raw starch further includes gluten.

33. The method of claim 31 wherein said raw starch further includes a plasticizer.

34. The method of claim 31 wherein said barrel further includes a feed section and a nozzle including a plurality of temperature control zones in said barrel extending from said feed section to said nozzle.

35. The method of claim 34 wherein said barrel adjacent to said feed section is maintained at a temperature less than about 150 degrees F.

36. The method of claim 34 wherein said plurality of temperature control zones in said barrel are set within the following temperature ranges:
zone 1 is set between about 35 to 150 degrees F.;
zone 2 is set between about 70 to 150 degrees F.;
zone 3 is set between about 50-300 degrees F.; and
zone 4 is set between about 200-375 degrees F.

37. The method of claim 31 wherein said mold is set at a temperature between about 35 to 65 degrees F.

38. The method of claim 31 wherein said mold includes a bushing and said bushing temperature is set between about 250 to 425 degrees F.
